(19) United States
(12) Patent Application Publication
(10) Pub. No.: US 2012/0102769 A1
(43) Pub. Date: May 3, 2012

(54) Mason ruler

(76) Inventor: Jaime Salvaro, Criciuma (BR)

(21) Appl. No.: 13/073,034

(22) Filed: Mar. 28, 2011

(30) Foreign Application Priority Data
Oct. 27, 2010 (BR) MU 9001197-0

(51) Int. Cl. G01C 15/10

(52) U.S. Cl. 33/404

(57) ABSTRACT

A mason ruler consisting of a central profile (27) made of solid wood and other materials, which has its own section in the two long parallel sides (28) and two smaller parallel sides (29). The extremities of the longer sides (28) of the section of profile (27) have recesses (30), which extend along the length of this central profile (27). O each lower side (29) and their two respective adjacent recesses (30), is mounted a letter-shaped profile U (25) preferably composed of aluminum. This ruler has integrated into its body at least one unit tool level (26), which may be a bubble level or any other principle of operation.

### FIELD OF THE INVENTION

This application claims the benefit of the priority date of Brazilian patent application No. MU 9001197-0 filed on 27 Oct. 2010.

This invention refers to an improvement in a mason ruler with a straight edge, which is a tool used by construction workers, mainly for smoothing mortar coating for walls, floors and ceilings, more popularly known as plaster, among other applications. It aims to bring further advantages to its use and lower cost.

### STATE OF THE ART

The use of the traditional straightedge or ruler of mason is widely known within the construction industry, which is a piece of rectangular profile commonly used for spreading and/or smoothing mortar in general, especially the mortars applied for coating walls, ceilings and floors. Several factors are taken into account to determine the qualities of a straightedge, the main being is its weight; the lighter it is, the better. Another is its resistance to deformation, besides its convenience when handling, and finally its cost. The rulers of mason in the state of the art are made of wood or aluminum tubular. The wooden rulers have as main positive feature, which is dimensional variety, since the wood can be easily cut in its width, thickness and length to best suit its purposed and especially, can be cut in its size to best suit the hands of the user, including to choose or even to design a ruler with the appropriate width and thickness to ergonomically fit between the hands, considering user's stature and anatomy, thus making the task more convenient. Another positive feature of a wooden ruler is its cost, since wood is a readily available, inexpensive and easily workable. But, the established wooden rulers of mason have some disadvantages because solid wood is heavier, thus requiring more physical strength of the user and causing greater fatigue; another drawback is the fact that the wood is very vulnerable to be used when frictioned against the mortar.

In contrast, the profile of established tubular aluminum rulers of mason have some advantages over wooden rule, especially the fact they weigh much less, causing less fatigue to the user and; also, aluminum rulers are less degradable by friction against the mortar. On the other hand, aluminum rulers offer considerable disadvantages, one being the fact they are obtained from the aluminum profiles with standard measures, and thus, do not offer variety of width and thickness, which hinders the acquisition of suitable rulers for the hands of the users; another drawback is the fact that aluminum is malleable, which makes them bend and deform with time, thus impairing the quality of work. In addition, aluminum rulers cost considerably higher and because of its higher market value as a metal, it was found a considerable number of thefts of aluminum strips for sale in junk shops.

### OBJECTIVES OF THE INVENTION

In order to solve such inconveniences, the present invention was developed, presenting a mason ruler constructed with a combination of wood and aluminum, thus congregating the positive characteristics of both materials and, at the same time, reducing its negative characteristics. The characteristics of the present ruler of mason consist of a wooden nucleus, whereas, the faces entering in attrition against the mortar, receive an aluminum profile cover. The body of this straightedge device is an integrated bubble level, giving the ruler an extra feature, allowing the user to check the smoothness and level of the mortar, without the need of an additional leveling tool.

### DESCRIPTION OF THE DRAWINGS

A detailed description making reference to the attached drawings is presented here, where:

FIG. 1 illustrates the straightedge in perspective;

FIG. 2 illustrates the straightedge in perspective and in enlarged detail;

FIG. 3 illustrates the straightedge in exploded perspective;

FIG. 4 illustrates the straightedge in top view;

FIG. 5 illustrates the straightedge in front view;

FIG. 6 illustrates the straightedge in top view, and

FIG. 7 illustrates a variant of constructive straightedge on top view.

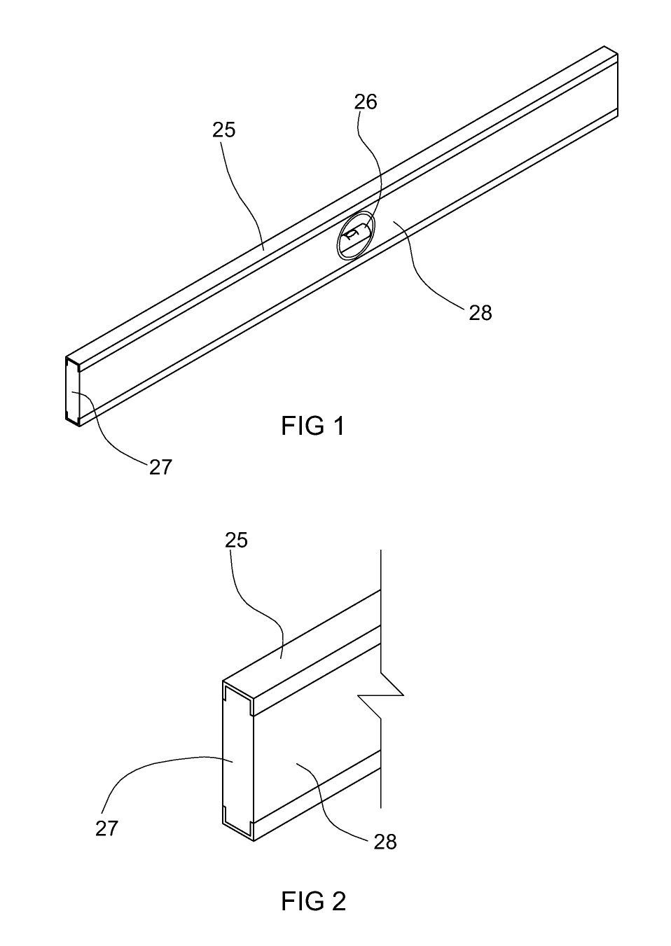

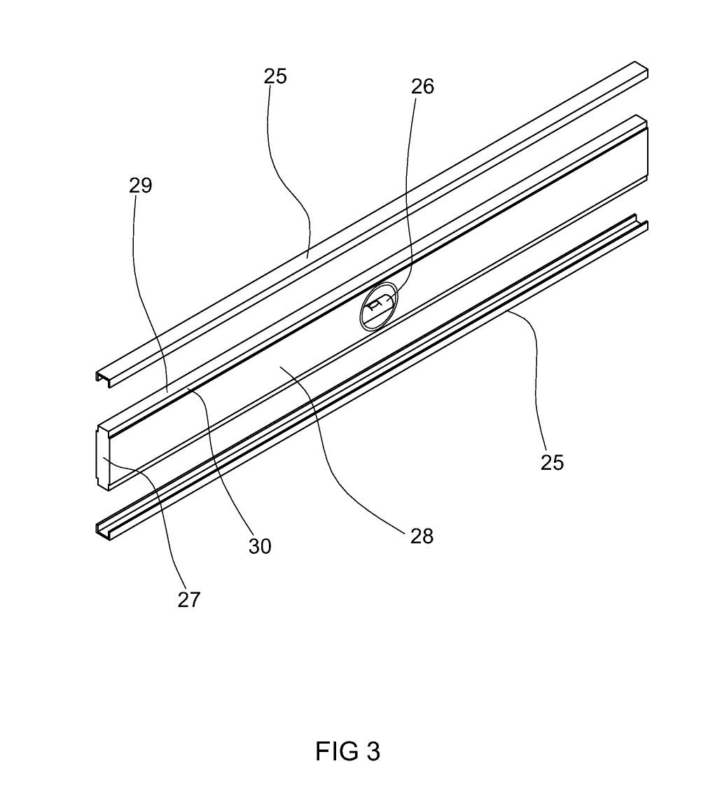

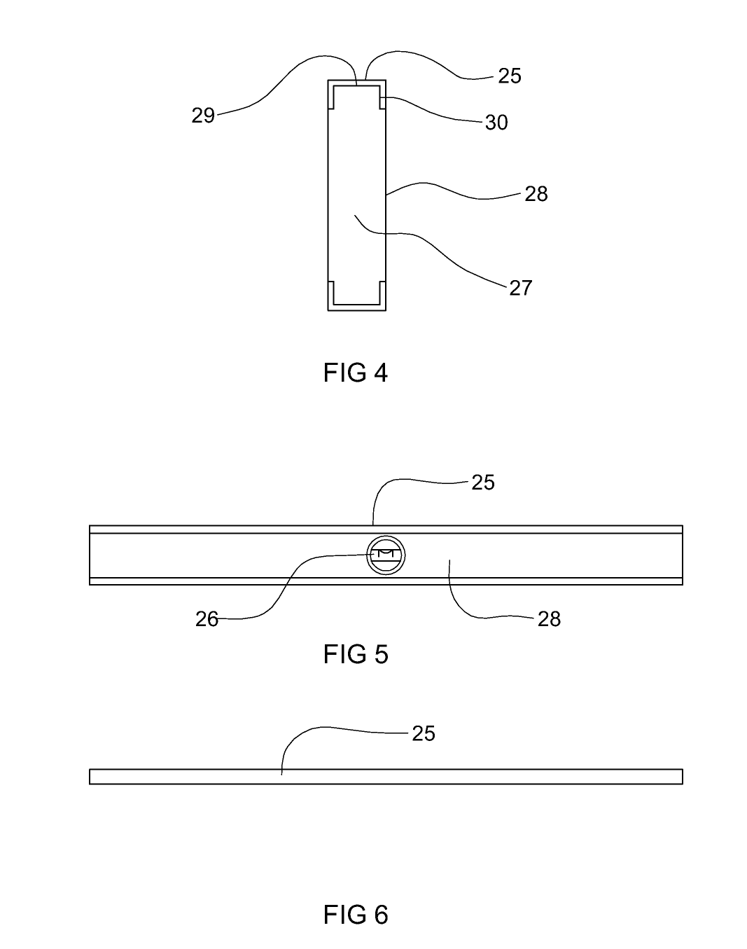

### DETAILED DESCRIPTION OF THE INVENTION

According to those illustrations and their details, the present consist of a mason ruler with a central profile (27) predominantly of a rectangular section with variable length, which is made of solid wood, veneer, sintered pellets or any polymeric material of hard physical and mechanical properties compatible to those of wood. Since this central profile (27) has its own section preferably with two parallel sides of (28) and two short parallel sides (29), the two ends of the long sides (28) of that section of the profile (27) have recesses (30), which extend along the entire length of this central profile (27). On each lower side (29) and their two respective adjacent recesses (30), is mounted a letter-shaped profile U (25), preferably made of aluminum, other metallic material or any material with compatible physical and mechanical characteristics. Those aluminum profiles (25) are fixed at central profile of wood (27) through appropriate adhesive, preferably added to the pressure exerted by the tight fit between the two pieces, or even, the setting can benefit from the longitudinal shaped grooves on the inner surfaces of the aluminum profile (25), which can also be held in the recesses (30) of the wooden profile (27), providing better fixation.

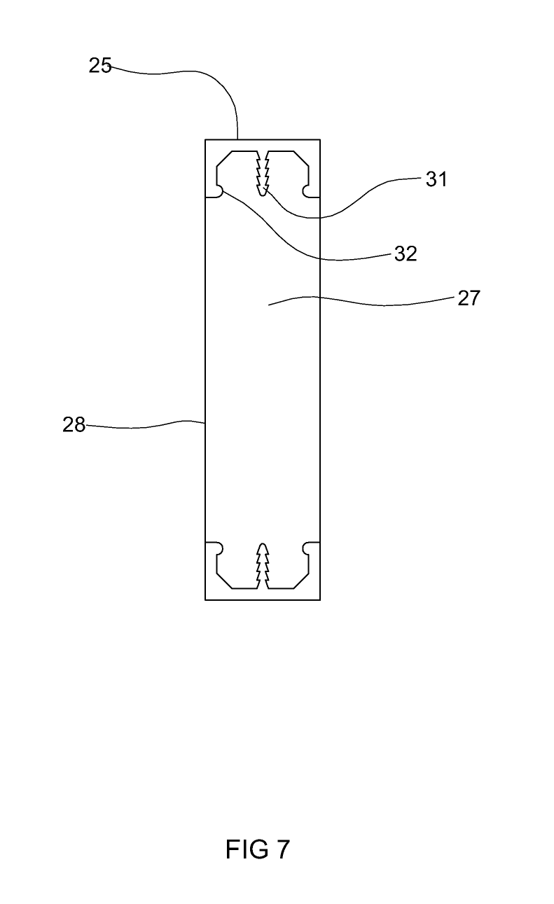

In turn, the wooden profile (27) has integrated into its body at least one unit-level tool (26), which may be a bubble level or any other operating principle, which is mounted on the longer sides (28) and is simply fixed on that face, or mounted within a recess or a passing opening equivalent carried through the related wooden profile (27), being that (26) is preferably mounted in middle region of the wooden profile (27), but can be arranged at any other point of the profile (27), according user's specific needs and preferences. As shown in FIG. 7, the aluminum profile (25) can still present protruding latches (32) in their internal sides for better adhesion to the wooden profile (27) and may also have internal continuous projections (31) or interspersed by empty spaces and these internal projections (31) may have slots or cash equivalents. These protrusions (31) are embedded in equivalent recesses performed on the smaller side (29) of the wooden profile (27) and its function is to provide greater unity to the whole.

The use of the present mason ruler is simple and practical. According to its use, nothing differs from other mason rulers and thus, the present ruler must be handled in a way that, the external face of one of the aluminum profiles (25) enters in contact with the mortar to the smoothened being. By visualizing the level (26), the user can verify the leveling of the smoothened mortar at the same time when spreads the mortar with the ruler.

The present mason ruler can be constructed in many sizes, not only in its length, but mainly in relation to size proportions between the longer sides (28) and shorter sides (29) of the wooden central profile (27), providing mason ruler with adequate ratios to the different sizes of hands, thus assisting with user's work productivity and comfort, without however increasing the cost of the ruler significantly.

1. A mason ruler characterized by a central profile section (27) predominantly rectangular and variable length, which is made of solid wood, laminated, pressed or crowded or any polymeric material of hard physical and mechanical compatible to those of wood. The related central profile (27) has its own section preferably with two parallel sides of (28) and two parallel shorter sides (29) and the two extremities of the longer sides (28) in the section of profile (27) have recesses (30), which extend along the entire length of this central profile (27). On each one of the smaller sides (29) and their two respective adjacent recesses (30) is mounted a letter-shaped profile U (25), preferably made of aluminum, or other metallic material, or any material with compatible physical and mechanical characteristics. The related aluminum profiles (25) are fixed in the wooden central profile (27) by means of an appropriate adhesive, preferably added to the pressure exerted by the tight fit between the two parts; or even with fixing occurring with the use of longitudinal shaped grooves in the inner faces of the aluminum profile (25), which can also be held in the recesses (30) of the wooden profile (27). Alternatively, the wooden profile (27) has integrated into its body, at least one unit-level tool (26), which may be a bubble level or any other operating principle, which is fitted on one of the biggest sides (28), simply fixed on the face, or mounted within a recess or on equivalent opening passing, carrying through the related wooden profile (27). The related level (26) is mounted preferably in the middle section of the wooden profile (27), but can be arranged at any other chosen point (27).
